(19) United States
(12) Patent Application Publication
(10) Pub. No.: US 2026/0155297 A1
(43) Pub. Date: Jun. 4, 2026

(54) COIL COMPONENT

(71) Applicant: Murata Manufacturing Co., Ltd., Kyoto-fu (JP)

(72) Inventor: Masashi MIYAMOTO, Nagaokakyo-shi (JP)

(73) Assignee: Murata Manufacturing Co., Ltd., Kyoto-fu (JP)

(21) Appl. No.: 19/462,122

(22) Filed: Jan. 28, 2026

Related U.S. Application Data
(63) Continuation of application No. PCT/JP2024/017022, filed on May 8, 2024.

(30) Foreign Application Priority Data
Aug. 12, 2023 (JP) 2023-131724

(51) Int. Cl. H01F 27/30; H01F 27/24; H01F 27/29

(52) U.S. Cl. CPC H01F 27/306; H01F 27/24; H01F 27/29

(57) ABSTRACT

A coil component that is less likely to vary in the distance between flange portions and a top plate of a core. The coil component includes a core made of a magnetic material, the core including a winding core portion, a first flange portion and a second flange portion respectively provided at a first end and a second end of the winding core portion opposite to each other in a length direction, and a top plate portion extending in a direction connecting the first flange portion and the second flange portion, with the winding core portion, the first flange portion and the second flange portion, and the top plate portion being integrated into the core. The first and second flange portions extend in all directions including a width direction and a height direction from the first and second ends of the winding core portion, respectively.

### CROSS-REFERENCE TO RELATED APPLICATIONS

This application claims benefit of priority to International Patent Application No. PCT/JP 2024/017022, filed May 8, 2024, and to Japanese Patent Application No. 2023-131724, filed Aug. 12, 2023, the entire contents of each are incorporated herein by reference.

### BACKGROUND

### Technical Field

The present disclosure relates to a coil component including a core including: a winding core portion around which a wire is wound; a first flange portion and a second flange portion provided at respective end portions of the winding core portion; and a top plate portion disposed so as to be connected between the first flange portion and the second flange portion. In particular, the present disclosure relates to the structure of the core.

### Background Art

For example, Japanese Unexamined Patent Application Publication No. 2021-39987 describes a coil component including: a core including a winding core portion around which a wire is wound, and a first flange portion and a second flange portion provided at respective end portions of the winding core portion; and a top plate fixed to the core with an adhesive in a state of spanning between the first flange portion and the second flange portion.

An object of the technique described in Japanese Unexamined Patent Application Publication No. 2021-39987 is to improve the adhesion between the core and the top plate. To achieve the object, the top plate has a first projection projecting toward the first flange portion and a second projection projecting toward the second flange portion, and the core and the top plate are connected to each other via the adhesive in a state in which the first flange portion and the first projection butt against each other and the second flange portion and the second projection butt against each other.

### SUMMARY

In the technique described in Japanese Unexamined Patent Application Publication No. 2021-39987, the core and the top plate are formed separately from each other and are connected to each other via the adhesive. Thus, the distance between the core and the top plate is likely to vary. Accordingly, the coil component is likely to vary in inductance value.

Accordingly, the present disclosure provides a coil component that is less likely to vary in the distance between a core and a top plate.

A coil component according to the present disclosure includes a core made of a magnetic material. The core includes a winding core portion, a first flange portion and a second flange portion respectively provided at a first end and a second end of the winding core portion opposite to each other in a length direction, and a top plate portion extending in a direction connecting the first flange portion and the second flange portion. The winding core portion, the first flange portion and the second flange portion, and the top plate portion being integrated into the core.

The coil component according to the present disclosure further includes a wire wound around the winding core portion; and a first terminal electrode and a second terminal electrode to which respective end portions of the wire are connected. The first terminal electrode and the second terminal electrode are respectively provided on the first flange portion and the second flange portion.

The coil component according to the present disclosure further includes the following configuration.

When respective directions orthogonal to the length direction are a width direction and a height direction and the width direction and the height direction are directions orthogonal to each other, the first flange portion and the second flange portion are provided in a state of extending in all directions including the width direction and the height direction from the first end and the second end of the winding core portion, respectively, the top plate portion is disposed parallel to the winding core portion with a predetermined space in the height direction between the top plate portion and the winding core portion, and a dimension of the top plate portion in the width direction is larger than a dimension in the width direction defined by an outer periphery of the wire wound around the winding core portion. Also, the first terminal electrode and the second terminal electrode are respectively provided on opposite sides of the first flange portion and the second flange portion in the height direction from sides where the top plate portion is located, and the core has a gap for dividing part of a magnetic flux loop passing through the winding core portion, the first flange portion, the second flange portion, and the top plate portion.

According to the present disclosure, the core includes the winding core portion, the first flange portion and the second flange portion, and the top plate portion. The winding core portion, the first flange portion and the second flange portion, and the top plate portion are integrated into the core without a structure for connecting the core and the top plate via an adhesive. Thus, the distance between the core and the top plate does not vary. In addition, according to the present disclosure, it is possible to integrally manufacture the core in the state of having the gap and to thus reduce variations in gap size.

As a result of these, it is possible to reduce variations in the inductance value of the coil component.

In addition, the core included in the coil component according to the present disclosure eliminates the need for including an adhesive. A material such as an adhesive or a resin is larger in coefficient of linear expansion than ferrite or alumina. Thus, there is a problem in that a core and a top plate including such a material are likely to crack. On the other hand. the present disclosure eliminates the need for including an adhesive, thus enabling a reduction in the risk of cracking and an increase in reliability.

In addition, the present disclosure eliminates the need for separately manufacturing the core and the top plate and for a step of connecting the top plate to the core to manufacture the coil component. Thus, it is possible to simplify the manufacturing process and to thus reduce the costs of the coil component.

### BRIEF DESCRIPTION OF THE DRAWINGS

FIG. 1 is a front view illustrating the exterior of a coil component according to Embodiment 1 of the present disclosure;

FIG. 2 is a sectional view of the coil component taken along line A-A in FIG. 1;

FIG. 3 is a front view illustrating the exterior of a coil component according to Embodiment 2 of the present disclosure;

FIG. 4 is a front view illustrating the exterior of a coil component according to Embodiment 3 of the present disclosure;

FIG. 5 is a front view illustrating the exterior of a coil component according to Embodiment 4 of the present disclosure;

FIG. 6 is a front view illustrating the exterior of a coil component according to Embodiment 5 of the present disclosure;

FIG. 7 is a front view illustrating the exterior of a coil component according to Embodiment 6 of the present disclosure; and

FIG. 8 is a front view illustrating the exterior of a coil component according to Embodiment 7 of the present disclosure.

### DETAILED DESCRIPTION

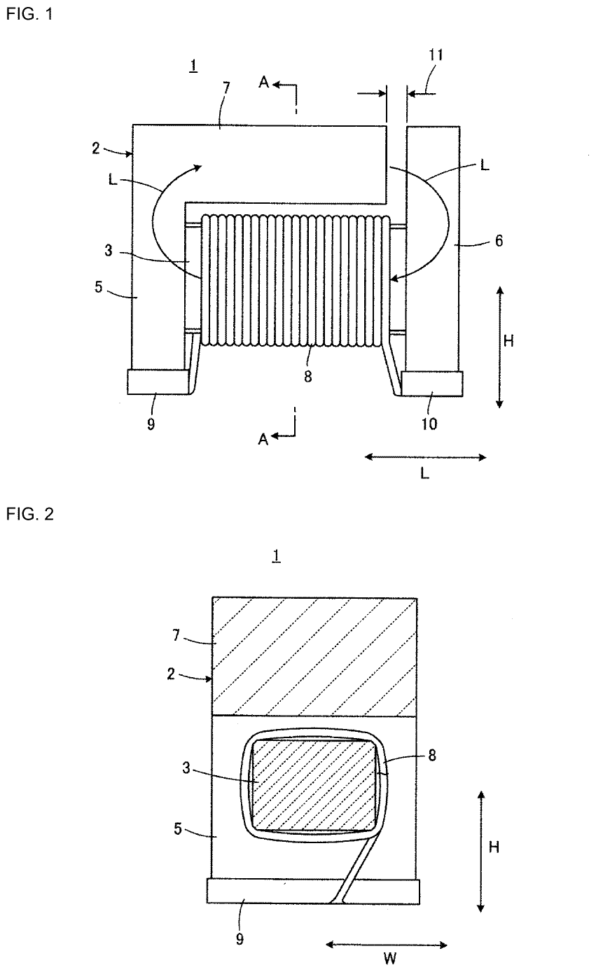

A coil component 1 according to Embodiment 1 of the present disclosure will be described with reference to FIGS. 1 and 2.

As illustrated in FIG. 1, the coil component 1 includes a core 2 made of a magnetic material. The core 2 includes a winding core portion 3, a first flange portion 5 and a second flange portion 6 respectively provided at a first end and a second end of the winding core portion 3 opposite to each other in a length direction L, and a top plate portion 7 extending in a direction connecting the first flange portion 5 and the second flange portion 6. The winding core portion 3, the first flange portion 5 and the second flange portion 6, and the top plate portion 7 are integrated into the core 2.

The coil component 1 further includes a wire 8 wound around the winding core portion 3.

The coil component 1 further includes a first terminal electrode 9 and a second terminal electrode 10, which are respectively provided on the first flange portion 5 and the second flange portion 6 and to which respective end portions of the wire 8 are connected.

The configuration of the coil component 1 will be described below in more detail. In the following description, respective directions orthogonal to the length direction L are a width direction W and a height direction H. The width direction W and the height direction H are directions orthogonal to each other.

The core 2 is preferably made of ferrite or a resin containing metal magnetic powder. For example, the dimension of the core 2 in the length direction L is 2.0 mm or more and 4.5 mm or less (i.e., from 2.0 mm to 4.5 mm), and the dimension of the core 2 in the width direction W is 1.2 mm or more and 3.2 mm or less (i.e., from 1.2 mm to 3.2 mm). Normally, the dimension in the length direction L is larger than the dimension in the width direction W. Although not particularly limited, the dimension in the height direction H is generally 1.6 mm or more and 4.0 mm or less (i.e., from 1.6 mm to 4.0 mm).

As is clear from FIGS. 1 and 2, the first flange portion 5 and the second flange portion 6 are provided in a state of extending in all directions including the width direction W and the height direction H from the first end and the second end of the winding core portion 3, respectively. In addition, the top plate portion 7 is disposed parallel to the winding core portion 3 with a predetermined space in the height direction H between the top plate portion 7 and the winding core portion 3, and the dimension of the top plate portion 7 in the width direction W is larger than the dimension in the width direction W defined by the outer periphery of the wire 8 wound around the winding core portion 3.

This configuration enables the core 2 to protect the wire 8 from the outside. Thus, this reduces the risk of the wire 8 coming into contact with an object from the outside and being damaged.

The first terminal electrode 9 and the second terminal electrode 10 are respectively provided on the opposite sides of the first flange portion 5 and the second flange portion 6 in the height direction from the sides where the top plate portion 7 is located. For example, the first terminal electrode 9 and the second terminal electrode 10 are formed by baking a conductive paste containing silver and nickel-plating and tinning the baked conductive paste. Instead, although not illustrated, terminal members formed by metal plates may be attached to the first flange portion 5 and the second flange portion 6 with an adhesive or caulking to serve as the first terminal electrode 9 and the second terminal electrode 10.

The wire 8 is connected to the first terminal electrode 9 and the second terminal electrode 10 by, for example, thermocompression bonding or laser welding. As illustrated in FIGS. 1 and 2, the wire 8 is normally connected to respective surfaces of the first terminal electrode 9 and the second terminal electrode 10 facing downward. However, the wire 8 may be connected to any part of each of the first terminal electrode 9 and the second terminal electrode 10.

The wire 8 is wound in the length direction L along the winding core portion 3. The coil component 1 including the wire 8 in this wound state may be referred to as a horizontally wound inductor. In the figures, the wire 8 is a single wire. However, the number of wires 8 may be two or more parallel to each other to reduce electrical resistance. In addition, the turns of the wire 8 wound around the winding core portion 3 may be in close contact with each other or separate from each other. Generally, in a coil component having a high inductance value, the turns of the wire 8 are in close contact with each other, and in a coil component having a low inductance value, the turns of the wire 8 are separate from each other.

As schematically represented by arrows L in FIG. 1, the core 2 has a magnetic flux loop passing through the winding core portion 3, the first flange portion 5, the second flange portion 6, and the top plate portion 7. Part of the magnetic flux loop is divided. In the present embodiment, a gap 11 is provided at the position on the top plate portion 7 connected to the second flange portion 6, thus dividing the magnetic flux loop. The gap 11 passes through the top plate portion 7 in the width direction W and the height direction H.

Control of the width of the gap 11 enables the coil component 1 to have a good balance between the inductance and the DC bias characteristic and thus enables the inductor to have an optimal balance.

The width of the gap 11 is, for example, 100 μm or more and 600 μm or less (i.e., from 100 μm to 600 μm). The gap 11 is filled with air. When the air part is excessively small, magnetic material characteristics are strongly exhibited, thus increasing variations in inductance value. This is because the relative permeability of a magnetic material is larger in variation than the relative permeability of air. On the other hand, when the air part is excessively large, air characteristics are strongly exhibited, thus reducing variations. Since the relative permeability of air μᵣ is 1, inductance is less likely to be obtained. In consideration of the balance, the width of the gap 11 is preferably 100 μm or more and 600 μm or less (i.e., from 100 μm to 600 μm) as described above.

The gap 11 may be provided at the position, opposite to the position illustrated in FIG. 1, on the top plate portion 7 connected to the first flange portion 5.

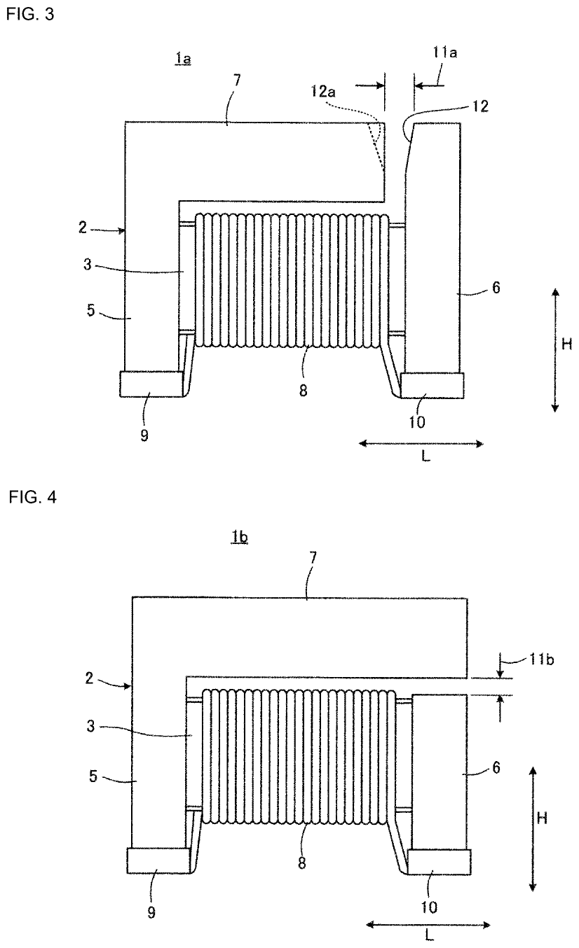

The other embodiments of the present disclosure will be described below with reference to FIGS. 3 to 8. FIGS. 3 to 8 correspond to FIG. 1. In FIGS. 3 to 8, the components corresponding to components illustrated in FIG. 1 have the same reference signs, and duplicate descriptions are omitted.

In FIG. 3, in a coil component 1a according to Embodiment 2 of the present disclosure, a gap 11a is provided at the position on the top plate portion 7 connected to the second flange portion 6 and passes through the top plate portion 7 in the width direction W and the height direction H similarly to the case of Embodiment 1. Embodiment 2 differs from the case of Embodiment 1 in that the end portion of the gap 11a in the height direction H located on the outer surface side of the top plate portion 7 is defined by an inclined surface 12 widening toward the outer surface of the top plate portion 7. In other words, the inclined surface 12 enables the gap 11a to widen toward the outer surface (upper surface in the figure) of the top plate portion 7. The inclined surface 12 enables the wire 8 to be wound around the winding core portion 3 to be more smoothly guided from the outside of the core 2 to the periphery of the winding core portion 3 in the height direction H.

An inclined surface 12a represented by a dotted line in FIG. 3 may be provided instead of the inclined surface 12. Alternatively, both the inclined surface 12 and the inclined surface 12a may be provided.

In FIG. 4, in a coil component 1b according to Embodiment 3 of the present disclosure, a gap 11b is provided at the position on the second flange portion 6 connected to the top plate portion 7 and passes through the second flange portion 6 in the width direction W and the length direction L. Embodiment 3 enables the top surface of the top plate portion 7 to have no gap and to thus be a completely flat surface. Thus, when the coil component 1b is mounted by a mounter, it is possible to reliably pick up the coil component 1b by vacuum suction.

The gap 11b may be provided at the position, opposite to the position illustrated in FIG. 4, on the first flange portion 5 connected to the top plate portion 7.

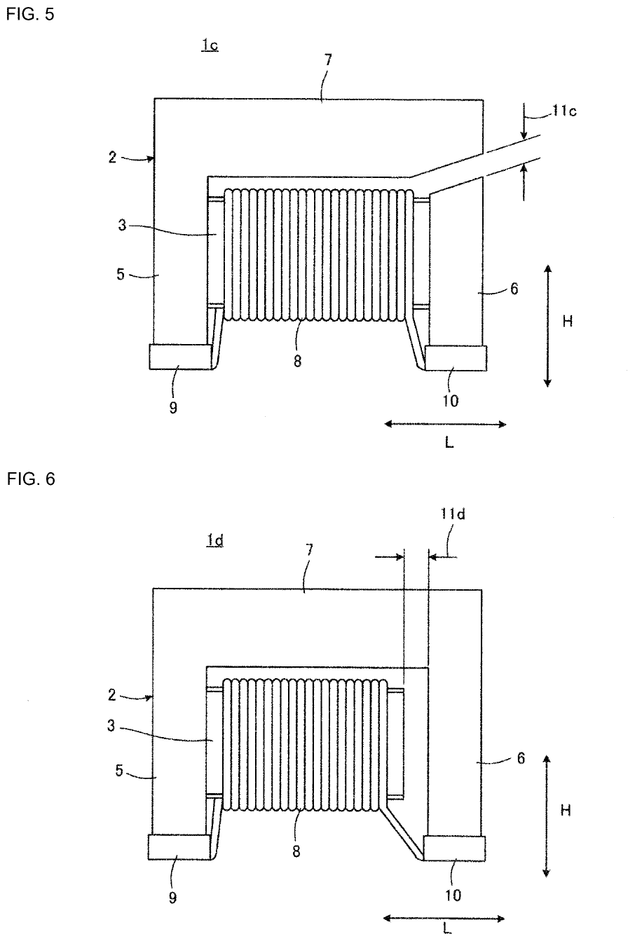

In FIG. 5, in a coil component 1c according to Embodiment 4 of the present disclosure, a gap 11c is provided at the position on the second flange portion 6 connected to the top plate portion 7 and passes through the second flange portion 6 in the width direction W and the length direction L similarly to the case of Embodiment 3. Embodiment 4 differs from the case of Embodiment 3 in that the gap 11c is inclined from the outer surface to the inner surface of the second flange portion 6 in a direction toward the winding core portion 3 and passes through the second flange portion 6 in the length direction. The inclination of the gap 11c enables the wire 8 to be more smoothly guided from the outside of the core 2 to the periphery of the winding core portion 3.

In FIG. 6, in a coil component 1d according to Embodiment 5 of the present disclosure, a gap 11d is provided at the position on the winding core portion 3 connected to the second flange portion 6 and passes through the winding core portion 3 in the width direction W and the height direction H. Embodiment 5 enables inhibition of a reduction in the mechanical strength of the coil component 1d due to the formation of the gap 11d because stress is less likely to be concentrated in the vicinity of the gap 11d.

The gap 11d may be provided at the position, opposite to the position illustrated in FIG. 6, on the winding core portion 3 connected to the first flange portion 5.

In Embodiment 1 to Embodiment 5 described above, the gaps 11, 11a, 11b, 11c, and 11d each also have the function of facilitating winding of the wire 8 around the winding core portion 3.

In addition, the gaps 11, 11a, 11b, 11c, and 11d according to Embodiment 1 to Embodiment 5 are provided at respective positions shifted from the central position in the top plate portion 7 in the length direction L toward the second flange portion 6 side. The disposition of the gaps 11, 11a, 11b, 11c, and 11d shifted from the central position in this manner facilitates winding of the wire 8 throughout substantially the entire region (from the first end to the second end) of the winding core portion 3 in the length direction L while the wire 8 is guided by using the gaps 11, 11a, 11b, 11c, and 11d. On the other hand, when the gaps 11, 11a, 11b, 11c, and 11d are provided at the central position in the length direction L, the wire 8 may be difficult to wind between the vicinity of the center of the winding core portion 3 in the length direction L and the second end.

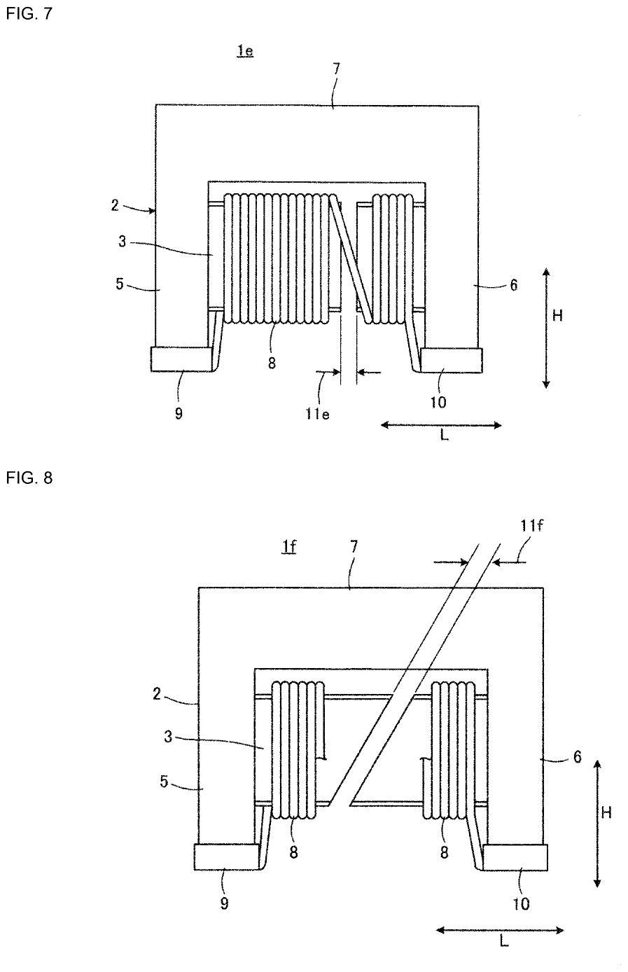

In FIG. 7, in a coil component 1e according to Embodiment 6 of the present disclosure, a gap 11e is provided at a position inside the winding core portion 3 in the length direction L and passes through the winding core portion 3 in the width direction and the height direction. The wire 8 is wound throughout substantially the entire region of the winding core portion 3 in the length direction L across the gap 11e. In addition, in Embodiment 6, the gap 11e is provided at the position shifted from the central position of the winding core portion 3 in the length direction L, for example, the position where the dimension of the winding core portion 3 in the length direction L is divided into two-thirds and one-third of the dimension.

Embodiment 6 realizes the structure in which two inductors having different inductance values on the left and right sides in FIG. 7 are connected in series. In the present embodiment, the two inductors have respective turns of the wire 8 whose numbers differ from each other. In this structure, the two inductors are regarded as separate inductors. Thus, this structure can be regarded as two series-connected inductors having different self-resonant frequencies. Accordingly, respective inductors have high resonant frequencies, thus enabling each inductor to have high impedance in a wide band.

The above operational effect can be mostly achieved without the gap 11e. The structure having the gap 11e more clearly achieves the operational effect because coupling between the two inductors is further reduced in this structure. In particular, in the coil component 1e illustrated in FIG. 7, the left-side inductor and the right-side inductor have different inductance values. Accordingly, for example, the left-side inductor handles low frequency, and the right-side inductor handles high frequency, thus enabling the coil component 1e to have wider band characteristics.

In FIG. 8, in a coil component 1f according to Embodiment 7 of the present disclosure, a gap 11f in an inclined state passes through the winding core portion 3. That is, the gap 11f passes through the winding core portion 3 in the height direction while the positions therein vary in the length direction L. In FIG. 8, to illustrate the gap 11f to be hidden by the wire 8, part of the wire 8 wound around the winding core portion 3 is omitted. Embodiment 7 enables the wire 8 to be wound around the winding core portion 3 without entering the gap 11f.

In a modification of Embodiment 7 described above, the gap 11f may be provided at a position shifted from the central position of the winding core portion 3 in the length direction L toward the first flange portion 5 side or the second flange portion 6 side. In addition, Embodiment 7 also realizes the structure in which two inductors having different inductance values on the left and right sides in FIG. 8 are connected in series. The two inductors may have respective turns of the wire 8 whose numbers differ from each other.

The present disclosure has been described above with reference to the illustrated embodiments, but other various modifications may be implemented within the scope of the present disclosure.

In addition, when the coil component according to the present disclosure is formed, configurations of different embodiments described in the specification may be partially replaced or combined.

The present disclosure includes the following embodiments.

<1> A coil component comprising a core made of a magnetic material, the core including a winding core portion, a first flange portion and a second flange portion respectively provided at a first end and a second end of the winding core portion opposite to each other in a length direction, and a top plate portion extending in a direction connecting the first flange portion and the second flange portion. The winding core portion, the first flange portion and the second flange portion, and the top plate portion are integrated into the core. The coil component further comprises a wire wound around the winding core portion; and a first terminal electrode and a second terminal electrode to which respective end portions of the wire are connected. The first terminal electrode and the second terminal electrode are respectively provided on the first flange portion and the second flange portion. Also, when respective directions orthogonal to the length direction are a width direction and a height direction and the width direction and the height direction are directions orthogonal to each other, the first flange portion and the second flange portion are provided in a state of extending in all directions including the width direction and the height direction from the first end and the second end of the winding core portion, respectively, the top plate portion is disposed parallel to the winding core portion with a predetermined space in the height direction between the top plate portion and the winding core portion, and a dimension of the top plate portion in the width direction is larger than a dimension in the width direction defined by an outer periphery of the wire wound around the winding core portion, the first terminal electrode and the second terminal electrode are respectively provided on opposite sides of the first flange portion and the second flange portion in the height direction from sides where the top plate portion is located, and the core has a gap for dividing part of a magnetic flux loop passing through the winding core portion, the first flange portion, the second flange portion, and the top plate portion.

<2> The coil component according to <1>, wherein the gap is provided at a position on the top plate portion connected to the first flange portion or the second flange portion and passes through the top plate portion in the width direction and the height direction.

<3> The coil component according to <2>, wherein an end portion of the gap in the height direction located on an outer surface side of the top plate portion is defined by an inclined surface widening toward an outer surface of the top plate portion.

<4> The coil component according to <1>, wherein the gap is provided at a position on the first flange portion or the second flange portion connected to the top plate portion and passes through the first flange portion or the second flange portion in the width direction and the length direction.

<5> The coil component according to <4>, wherein the gap is inclined from an outer surface to an inner surface of the first flange portion or the second flange portion in a direction toward the winding core portion and passes through the first flange portion or the second flange portion in the length direction.

<6> The coil component according to <1>, wherein the gap is provided at a position on the winding core portion connected to the first flange portion or the second flange portion and passes through the winding core portion in the width direction and the height direction.

<7> The coil component according to <1>, wherein the gap is provided at a position inside the winding core portion in the length direction and passes through the winding core portion in the width direction and the height direction.

<8> The coil component according to <7>, wherein the gap is provided at a position shifted from a central position of the winding core portion in the length direction.

<9> The coil component according to <7> or <8>, wherein the gap passes through the winding core portion in the height direction while positions in the gap vary in the length direction.

What is claimed is:

1. A coil component comprising:
a core including a magnetic material, the core comprising a winding core portion, a first flange portion and a second flange portion respectively at a first end and a second end of the winding core portion opposite to each other in a length direction, and a top plate portion extending in a direction connecting the first flange portion and the second flange portion, with the winding core portion, the first flange portion and the second flange portion, and the top plate portion being integrated into the core;
a wire wound around the winding core portion; and
a first terminal electrode and a second terminal electrode to which respective end portions of the wire are connected, the first terminal electrode and the second terminal electrode being respectively on the first flange portion and the second flange portion, wherein
when respective directions orthogonal to the length direction are a width direction and a height direction and the width direction and the height direction are directions orthogonal to each other,
the first flange portion and the second flange portion extend in all directions including the width direction and the height direction from the first end and the second end of the winding core portion, respectively,
the top plate portion is parallel to the winding core portion with a predetermined space in the height direction between the top plate portion and the winding core portion, and a dimension of the top plate portion in the width direction is larger than a dimension in the width direction defined by an outer periphery of the wire wound around the winding core portion,
the first terminal electrode and the second terminal electrode are respectively on opposite sides of the first flange portion and the second flange portion in the height direction from sides where the top plate portion is located, and
the core has a gap for dividing part of a magnetic flux loop passing through the winding core portion, the first flange portion, the second flange portion, and the top plate portion.

2. The coil component according to claim 1, wherein
the gap is at a position on the top plate portion connected to the first flange portion or the second flange portion and passes through the top plate portion in the width direction and the height direction.

3. The coil component according to claim 2, wherein
an end portion of the gap in the height direction located on an outer surface side of the top plate portion is defined by an inclined surface widening toward an outer surface of the top plate portion.

4. The coil component according to claim 1, wherein
the gap is at a position on the first flange portion or the second flange portion connected to the top plate portion and passes through the first flange portion or the second flange portion in the width direction and the length direction.

5. The coil component according to claim 4, wherein
the gap is inclined from an outer surface to an inner surface of the first flange portion or the second flange portion in a direction toward the winding core portion and passes through the first flange portion or the second flange portion in the length direction.

6. The coil component according to claim 1, wherein
the gap is at a position on the winding core portion connected to the first flange portion or the second flange portion and passes through the winding core portion in the width direction and the height direction.

7. The coil component according to claim 1, wherein
the gap is at a position inside the winding core portion in the length direction and passes through the winding core portion in the width direction and the height direction.

8. The coil component according to claim 7, wherein
the gap is at a position shifted from a central position of the winding core portion in the length direction.

9. The coil component according to claim 7, wherein
the gap passes through the winding core portion in the height direction while positions in the gap vary in the length direction.

10. The coil component according to claim 8, wherein
the gap passes through the winding core portion in the height direction while positions in the gap vary in the length direction.
